(19) United States
(12) Patent Application Publication
(10) Pub. No.: US 2011/0274980 A1
(43) Pub. Date: Nov. 10, 2011

(54) METHOD OF PRODUCING AN ELECTROCHEMICAL CELL AND ARTICLES PRODUCED THEREFROM

(75) Inventors: MICHAEL LUNT, ABINGTON, CT (US); MURALI SETHUMADHAVEN, ACTON, MA (US); GRETCHEN KOLEK, DANIELSON, CT (US)

(73) Assignee: ROGERS CORPORATION, Rogers, CT (US)

(21) Appl. No.: 13/187,034

(22) Filed: Jul. 20, 2011

Related U.S. Application Data
(62) Division of application No. 12/030,991, filed on Feb. 14, 2008.
(60) Provisional application No. 60/890,325, filed on Feb. 16, 2007.

(51) Int. Cl. H01M 4/02; H01M 4/04

(52) U.S. Cl. 429/246; 29/623.5; 29/623.4

(57) ABSTRACT

A method of producing an electrode assembly comprises disposing a thermoplastic polymer powder between a first surface of a first electrode and a first surface of a microporous separator to form a separator/electrode pre-assembly; and adhering the first surface of the first electrode to the first surface of the microporous separator via the thermoplastic polymer powder to form a separator/electrode assembly, wherein the adhesive thermoplastic polymer does not form a solid layer.

### CROSS-REFERENCE TO RELATED APPLICATION

This application is a U.S. Divisional Application claiming the benefit of U.S. application Ser. No. 12/030,991 filed on Feb. 14, 2008 and published as U.S. Publication. No. 2008/0199781 A1, which claims the benefit of U.S. Provisional Application Ser. No. 60/890,325 filed on Feb. 16, 2007, all of which are incorporated herein by reference in their entirety.

### BACKGROUND

This invention relates to methods for the production of a multi-layer, microporous film laminate for a lithium battery anode, and the laminates formed thereby.

Electrochemical cells generally comprise an anode and a cathode, and an ion conducting electrolyte disposed between the two electrodes. In the case of lithium ion batteries, the electrolyte is capable of intercalating lithium ions. A separator is interposed between positive and negative electrodes in order to electronically insulate the electrodes and to retain the electrolyte.

In known methods for the manufacture of lithium ion batteries, the two electrodes are procured in roll form, the cathode is coated with lithium-active components, and then the anode and/or cathode are slit to the desired width. The electrodes and a microporous separator are then stacked or wound together to form a layered “jelly roll.” The slitting process can produce electrically conductive windings that, when trapped in the batteries, can cause short circuits, reducing the battery life and efficiency. In addition, the manufacturing process involves handling of thin material ranging in thickness from less than 0.5 to 4 mils (13 to 102 micrometers), which have poor tear strength and thus poor handling properties. Such handling and assembly can be difficult and time consuming, and can result in damage and loss of material resulting in lower yields.

Another drawback to current lithium ion batteries and in one of their methods of manufacture is that during packaging, pressure is exerted upon the individual cell layers, which can cause edges and corners of the layers in each cell to be bent, crushed, or damaged. Damage to the electrode films results in non-uniform utilization of the active materials, which in turn, can lead to lithium plating and loss of battery life. In addition, the pressure exerted on the electrode layers can cause the separator to split, which also results in possible shorting within the battery.

### SUMMARY

The above deficiencies in the art are alleviated by a method of producing an electrode assembly comprising disposing a thermoplastic polymer powder between a first surface of a first electrode and a first surface of a microporous separator to form a separator/electrode pre-assembly; and adhering the first surface of the first electrode to the first surface of the microporous separator via the thermoplastic polymer powder to form a separator/electrode assembly, wherein the adhesive thermoplastic polymer does not form a solid layer.

An electrode assembly accordingly comprises a thermoplastic polymer adhesively disposed between a first surface of a first electrode and a first surface of a microporous separator, wherein the thermoplastic polymer does not form a solid layer.

### DRAWINGS

FIG. 1 is a schematic diagram of a separator/electrode pre-assembly.

FIG. 2 is a schematic diagram of a lamination process of a separator/electrode pre-assembly.

FIGS. 3A and 3B are schematic diagrams of a separator/electrode pre-assembly.

FIG. 4 is a schematic diagram of a lamination process of a separator/electrode pre-assembly.

FIG. 5 is a schematic diagram of a second separator/electrode pre-assembly.

FIG. 6 is a schematic diagram of a second separator/electrode assembly obtained by laminating a second separator/electrode pre-assembly.

FIG. 7 is a schematic diagram of a second separator/electrode pre-assembly.

FIG. 8 is a schematic diagram of a second separator/electrode assembly obtained by laminating a second separator/electrode pre-assembly.

FIG. 9 is a schematic diagram of multiple electrodes on a continuous separator membrane prior to cutting along dotted lines.

### DETAILED DESCRIPTION

The inventors hereof have unexpectedly found that in the manufacture of lithium ion battery assemblies, sealing the edges of the microporous separator and an electrode prior to winding or lamination of the separator and electrode reduces the steps required to manufacture the battery, eases difficult manual handling of thin films, and increases the safety of the battery. The edges are sealed using a thin film or powder comprising a thermoplastic adhesive polymer having a melting point lower than the melting point of the microporous separator and/or the binder used in the electrode active material. The edges can accordingly be sealed without melting and/or altering the micropores of the separator or the electrode active material.

In another embodiment, the inventors hereof have unexpectedly found that in the manufacture of lithium ion battery assemblies, sealing a portion of the surfaces of the microporous separator and an electrode prior to winding or lamination of the separator and electrode also reduces the steps required to manufacture the battery, eases difficult manual handling of thin films, and increases the safety of the battery. In this embodiment, the sealing is accomplished by use of a thermoplastic adhesive polymer distributed over all or a portion of the surfaces of the microporous separator and the electrode, wherein the thermoplastic adhesive polymer does not form a solid layer. The powder comprises a thermoplastic adhesive polymer having a melting point lower than the melting point of the microporous separator and/or the binder used in the electrode active material. Portions of the microporous separator and the electrode can accordingly be sealed without melting and/or altering the micropores of the separator or the electrode active material.

In practice, in one embodiment, the adhesive is disposed between a first electrode and a microporous separator at the edges thereof, or over a surface thereof, to form a first separator/electrode pre-assembly. The pre-assembly is laminated to adhere the edge(s) and/or surface(s) of the first electrode to the microporous membrane via the adhesive, providing a first separator/electrode assembly. Laminating the separator/electrode pre-assembly can be effected by roll lamination or flat bed lamination. In one embodiment, the edges of both the cathode and the anode are sealed to the microporous separator using the adhesive. Sealing can be performed either sequentially or simultaneously.

The adhesive is accordingly selected so as to allow lamination at a temperature less than the softening point or melt temperature of the microporous separator and greater than or equal to the softening point or melt temperature of the adhesive. The adhesive is also selected so as to provide adhesion between the electrode and the microporous separator, for example upon lamination of the pre-assembly. The particular adhesive material will therefore depend on the particular materials used for the electrodes and microporous separator.

Anodes for use in lithium ion batteries are known, and can comprise a metal foil anode current collector and an anode active layer coated on one or both sides of the anode collector. The anode current collector comprises a metal foil such as a copper, nickel, or stainless foil. At one end of the anode current collector there is an exposed part on which no active layer is coated. The anode lead is attached to this uncoated part.

The anode active layer can comprise known active materials, e.g., carbonaceous materials such as non-graphitizable carbon, artificial graphite, natural graphite, cokes (including pitch coke, needle coke, and petroleum coke), graphites, glassy carbons, organic high molecular weight compound firing body, carbon fiber, activated carbon, and carbon blacks. A polymeric binder can also be present, as well as other metal oxides, as is known in the art.

A volume density of the anode active layer can be about 1.0 to about 2.2 g/cm³, and more specifically from about 1.2 to about 2.0 g/cm³. An average void diameter of the anode active layer can be about 0.2 to about 5 micrometers, and more specifically about 0.5 to about 4 micrometers. High volume density and small average void diameter can lower the lithium anode active layer solvent permeability, resulting in low electrolytic activity. Likewise, low volume density and large average void diameter can also result in less than optimal electrode activity due to insufficient contact between the metal foil and lithium active material.

A cathode for a lithium ion battery comprises a metal oxide lithium active material for releasing and inserting lithium, a conductive material added to give conductivity, and a binder for fixing the metal oxide active material and the conductive material to an aluminum collecting body. Specific metal oxide active materials include lithium cobalt oxide, and iron phosphate doped with small amounts of metal ions such as aluminum, niobium, and zirconium.

Binders for use with the electrode active materials are known, and include fluoropolymers such as polytetrafluoroethylene (PTFE), polyvinylidene fluoride (PVDF), and the like.

The microporous separators can be either ceramic or polymeric. In one embodiment the microporous separator is a crosslinked polymer network derived from various metal alkoxides, an optional crosslinkable water-soluble organic polymeric binder, and a crosslinking agent. In one embodiment, the microporous separator is formed by removing liquid from a gel-forming composition comprising a sol or a sol-gel, a polymeric binder, and a liquid medium.

Suitable materials for forming a sol include metal alkoxides, for example aluminum, tin, zirconium, barium, titanium, silicon alkoxide, and the like. Aluminum alkoxides can be used to form xerogels, such as “pseudo-boehmite” sols, which are hydrated aluminum oxides having the chemical formula Al₂O₃.xH₂O wherein x is 1.0 to 1.5. Pseudo-boehmites are distinct from anhydrous aluminas (Al₂O₃, such as alpha-alumina and gamma-alumina), and hydrated aluminum oxides of the formula Al₂O₃.xH₂O wherein x is less than 1.0 or greater than 1.5.

The gel-forming composition can further comprise a crosslinkable, water soluble polymeric binder. After crosslinking, the crosslinked polymer has a glass transition temperature (Tg) of at least 50° C. or greater, specifically about 50° C. to about 200° C., and more specifically about 75° C. to about 150° C. Preferably, the Tg of the crosslinked polymer is not substantially affected by the presence of water, electrolytes, or other additives used in lithium batteries. After exposure to electrolyte, the Tg of the polymer is reduced by about 25% or less, specifically about 10% or less, and more specifically about 5% or less.

A variety of polymers can accordingly be used as the crosslinkable polymeric binder, provided that the polymer meets the above Tg and solubility characteristics. Suitable polymers include, for example, homopolymers and copolymers derived from the polymerization of vinyl acetate, polyvinyl alcohol, polyethylene oxide, maleic anhydride and derivatives and esters thereof, alkylated polyethylene oxide, polyvinyl pyrrolidone, polyvinyl butyral, acrylamide, vinyl ether, ethyleneimines, epoxy compounds, and the like. Other suitable binders include melamine formaldehydes, urea formaldehydes, gelatin, starch, and copolymers of cellulosics. Combinations comprising at least one of the foregoing polymers can also be used. Specific exemplary polymers include polyvinyl acetate, polyvinylcohol, polyethylene oxide, polyvinyl pyrrolidone, copolymers of the foregoing, or a combination comprising at least one of the foregoing polymers.

The relative amount of sol and crosslinkable polymeric binder will depend on the particular sol and binders used and the desired properties of the microporous membrane, and can be readily determined by one of ordinary skill in the art without undue experimentation. In one embodiment, the crosslinkable polymeric binder is present in an amount of about 3 to about 200% by weight of the sol, specifically about 5 to about 70% by weight of the sol in the gel-forming composition.

The liquid medium in the gel-forming composition comprises water and optionally a protic organic solvent. The choice of liquid medium depends on several factors including compatibility with the sol and binder in the gel-forming composition. Exemplary protic organic solvents include methanol, ethanol, isopropanol, 1-propanol, 1-butanol, 2-butanol, ethylene glycol, propylene glycol, 2-methoxyethanol, 2-ethoxyethanol, and 2-butoxyethanol. Other alcohols and glycols, or a combination comprising at least one of the foregoing alcohols and glycols can also be used. A specific organic solvent is ethanol. Small amounts, e.g., up to 5 volume percent of other organic solvents can be present for example various ketones, esters, hydrocarbons, or a combination comprising at least one of the foregoing organic solvents.

A method of manufacture of a microporous membrane comprises forming the gel-forming composition in an aqueous liquid medium as described above; forming a layer of the mixture; and removing the liquid medium to form the microporous membrane. After the gel-forming composition is formed into a layer, the liquid medium is substantially removed to provide a dried, microporous membrane. Removal of the liquid medium can be accomplished by a suitable drying process, such as blowing hot air over the layer at a high velocity, or exposure of the layer to ambient air conditions. As the liquid is removed from the formed gel-forming composition by, for example, evaporation, large capillary forces are exerted on the pores, forming a microporous membrane. The microporous membrane comprises a dried three-dimensional solid gel network with pores that are substantially continuously interconnected from one outermost surface of the membrane through to an opposite outermost surface of the membrane.

In another embodiment, the microporous membrane is a polymer, for example a polyolefin such as polyethylene, polypropylene, copolymers comprising ethylene and/or propylene, and the like. Microporous membrane separators comprising fluorinated polymers are also known, for example polytetrafluoroethylene, polyvinylidenefluoride, and the like.

The microporous membrane can be characterized using a variety of parameters, including average pore diameter, size of particulates that can pass through the pores, pore volume, and the like. The pores of the microporous membranes have an average pore diameter of about 1 nanometer to about 1,000 nanometers, and more specifically about 10 nanometers to about 300 nanometers. The amount of pores in a microporous membrane may be characterized by the pore volume, which is the volume in cubic centimeters of pores per unit weight of the microporous membrane. In one embodiment, the microporous membrane has a pore volume of about 0.02 to about 2.0 cm³/g, specifically about 0.3 to about 1.0 cm³/g, more specifically about 0.4 to about 0.7 cm³/g. In a specific embodiment, the microporous membrane has a porosity of about 20% to about 80%, specifically about 30% to about 70%, and more specifically about 40% to about 60%. An exemplary porosity is about 50%. In addition, the microporous membrane has a thickness of about 1 to about 50 micrometers, specifically about 2 to about 25 micrometers, and more specifically about 3 to about 15 micrometers.

Exemplary adhesive materials for use with the above described and other anode, cathode, and separator materials include thermoplastic polyolefin polymers such as polyethylene, polypropylene, polyethylene copolymers, and polypropylene copolymers, for example copolymers of ethylene and propylene. Copolymers are especially useful, for example copolymers comprising units derived from ethylene, propylene, and fluorinated olefin monomers such as 1,1-difluoroethylene, 1,1,2,2-tetrafluoroethylene, hexafluoroethylene, and hexafluoropropylene.

In use, the adhesive can be in the form of a solid film, a porous film, e.g., a porous polyethylene film available under the trade name SOLUPOR® from DSM Unlimited, or a powder. Exemplary powders include copolymers of 1,1-difluoroethylene and hexafluoropropylene, which are available under the trade name HYLAR SNC®, from Solvay Solexis.

The adhesive can also be mixed into the active layer of an electrode in addition to the binder, or as a partial or full replacement for the binder. The amount of adhesive is selected so as to provide adhesion, without substantially adversely affecting the operational efficiency of the active layer. Thus, relatively small amounts are used, so as to not provide a solid layer of the adhesive polymer, or substantially coat the majority of the active material. Exemplary amounts are less than about 9.9 percent by weight, specifically about 0.5 to about 5 percent by weight, based on the total weight of the active layer.

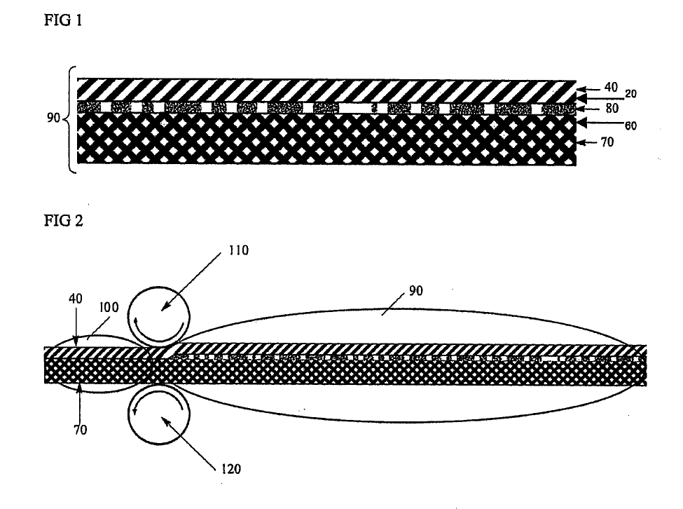

A specific embodiment for the manufacture of an electrode assembly for a lithium ion battery is shown in FIGS. 1-2. FIG. 1 illustrates a first separator/electrode preassembly 90, which has a non-continuous thermoplastic polymer powder layer 80 disposed between a first surface 20 of a microporous separator 40 and a first surface 60 of a first electrode 70. The non-continuous thermoplastic polymer powder layer 80 is disposed in partial contact with microporous membrane separator 40 and first electrode 70, in that it does not form a continuous layer between separator 40 and electrode 70. After the edges of the microporous separator 40 and electrode 70 are evenly aligned, FIG. 2 illustrates laminating the first separator/electrode pre-assembly 90 by double roll lamination through two rolls 110 and 120 to produce a first separator/electrode assembly 100 adhered by the adhesive. Press lamination (not shown) can also be used. Conditions for lamination are readily determined by those of ordinary skill in the art, depending on the materials used in the electrodes, particularly any binder in the active layer, the material used in the membrane, the Tg of the adhesive material, and like considerations. Exemplary conditions include a process temperature of about 50 to about 330° C. at a pressure of about 1 to about 50 N/cm at the rollers (where roll lamination is used) or 1 to 100 pounds per square inch of pressure (where press lamination is used). T

While sufficient adhesive is deposited between microporous separator 40 and electrode 70 to improve the handling of the assembly, the adhesive does not cover the entire surfaces thereof. In one embodiment, about 50% or less of the surface of electrode 70 is covered by adhesive, specifically less than about 40%, more specifically less than about 30%, even more specifically less than about 20%, and still more specifically about 1% to about 15%. The adhesive powder can be distributed evenly across the surface, or in a pattern, for example, more adhesive may be deposited at the edges of the membrane and electrode, and less in the center.

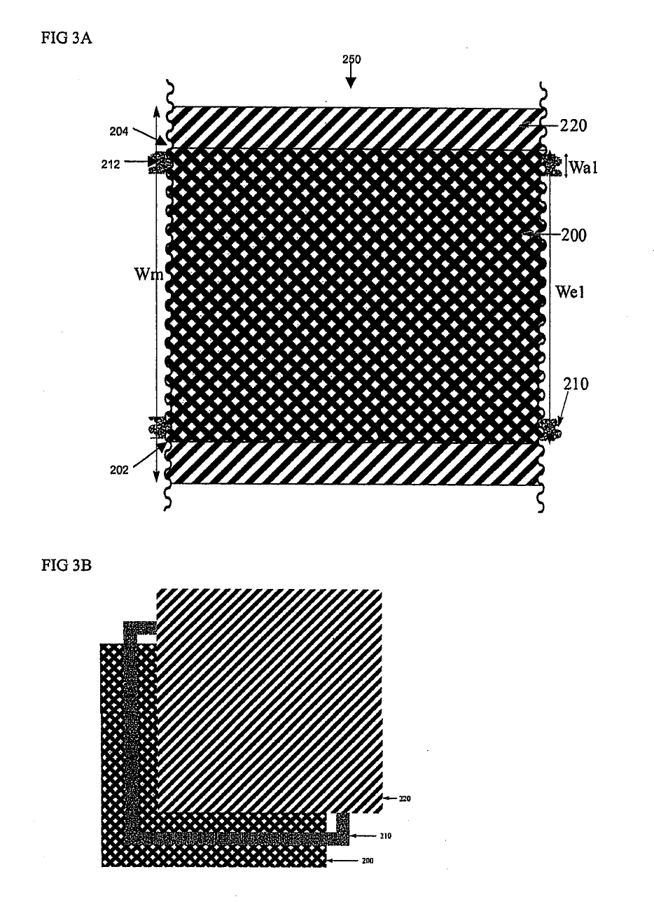

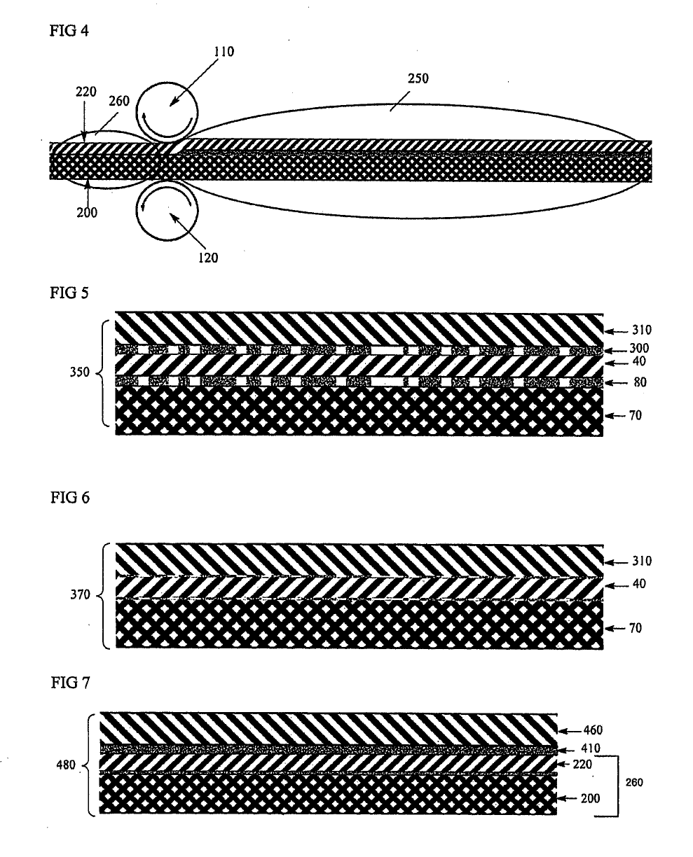

Another specific embodiment is shown in FIGS. 3-4. FIG. 3A illustrates a top view of first separator/electrode pre-assembly 250 with a thermoplastic adhesive polymer film layer 210 having a width W^{a1}, which is disposed between, and along the edges of, a first surface of a microporous separator 220 having a width W^{m} and a first surface of a first electrode 200 having a width W^{e1}. In one embodiment, the microporous separator 220 is wider than the first electrode, having a W^{m} value greater than W^{e1}. Width W^{a1} is less than ½(W^{e1}), preferably less than ¼(W^{e1}). In one embodiment, Width W^{a1} is less than 20 percent of width W^{e1}, specilically 0.1 to 10 percent of width W^{e1}. It will be understood that the length of the assembly is not limited and can be as large as it is advantageous to use in a press, or, preferably in a continuous manufacturing setting. At least one strip of the adhesive thermoplastic polymer film layer 210 is disposed along the edges of the microporous membrane separator 220 and the first electrode 200. As shown in FIG. 3A, a first strip 210 is disposed along a first edge 202 of first electrode 200, and a second strip 212 disposed along the opposite edge 204 electrode 200. The width W^{a} of each adhesive strip may or may not be the same. In a preferred embodiment, as shown in FIG. 3B, four strips are used. The strips can be separate or contiguous, and provide a “window pane” around electrode 200.

In another embodiment, the thermoplastic adhesive powder can be deposited between the surface of the separator and the electrode as described above, in addition to use of the strip(s) 210. In still another embodiment, the thermoplastic adhesive powder can be deposited between the surface of the separator and the electrode to form the strip(s) 210. In this embodiment, the powder can be deposited thickly to form a continuous layer, as long as a substantial amount of the surface of the active layer and the microporous membrane remain in contact.

As illustrated in FIG. 4, after the strip(s) 210 are positioned, the first separator/electrode pre-assembly 250 is laminated, for example by double roll lamination through two rolls 110 and 120 to produce a first separator/electrode assembly 260 wherein the microporous separator 220 is at least in partial contact with the electrode 200.

Additional separator/electrode pre-assemblies and assemblies are illustrated in FIGS. 5-6. FIG. 5 illustrates a second type of separator/electrode pre-assembly 350 comprising a non-continuous adhesive thermoplastic polymer powder layer 80 disposed between a first surface of a microporous membrane separator 40 and a first surface of a first electrode 70. A second non-continuous adhesive thermoplastic polymer powder layer 300 is disposed between a second surface opposite the first surface of the microporous membrane separator 40 and a first surface of a second electrode 310. The non-continuous thermoplastic polymer powder layer 80 is disposed between and is in partial contact with the microporous membrane separator 40 and the first electrode 70, and the non-continuous thermoplastic polymer powder layer 300 is disposed between and is in partial contact with the microporous membrane separator 40 and the second electrode 310.

FIG. 6 illustrates a second separator/electrode assembly 370 produced after laminating the second separator/electrode pre-assembly 350 by double roll or press lamination. The microporous separator 40 is at least in partial contact with the first electrode 70 and the second electrode 310. In another embodiment (not shown), the pre-assembly comprising electrode 70, powder 80, and microporous membrane 40 can be laminated to provide a first separator/electrode assembly (i.e., assembly 100 above), followed by deposition of powder 300 between separator 40 and electrode 310, then a second lamination.

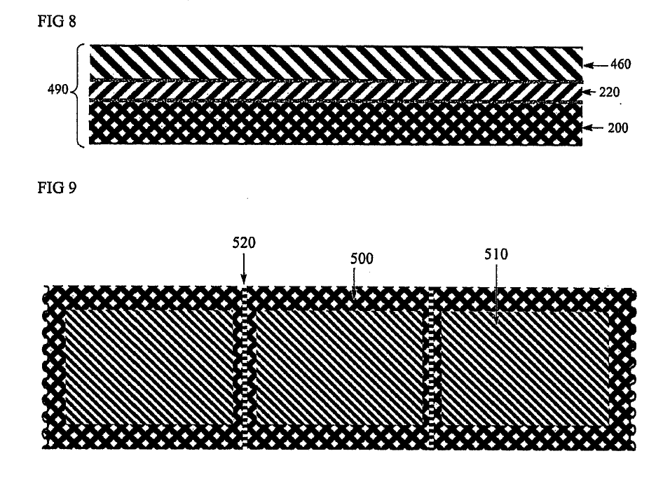

Yet another specific embodiment is shown in FIGS. 7-8. FIG. 7 illustrates a separator/electrode pre-assembly 480, having a thermoplastic polymer film layer 410 disposed between a first surface of a second electrode 460 and a second surface opposite the first surface of a microporous separator 220 that is part of a laminated first electrode/separator assembly 260. The thermoplastic polymer film layer 410 is disposed between and is in partial contact with the microporous membrane separator 220 that is part of the first electrode/separator assembly 260, and the second electrode 460. FIG. 8 illustrates a second separator/electrode assembly 490 produced after laminating the second separator/electrode pre-assembly 480 by double roll or other lamination. The microporous separator 220 is at least in partial contact with the first electrode 200 and the second electrode 460. In another embodiment (not shown), electrode 200, first adhesive layer 80, separator 200, second adhesive layer 410, and second electrode 460 are all aligned, and laminated at the same time to produce assembly 490.

Another specific embodiment is described in FIG. 9. A continuous roll of separator 500 has thereon disposed electrodes 510. The electrode 510 can be continuous (not shown), or evenly spaced pieces as shown in FIG. 9. Also shown in FIG. 9 using broken lines are adhesive strips as described above, disposed between the electrode 510 and the separator 500. The electrode 510 and the separator 500 are at least in partial contact. An electrode/separator assembly can be cut along the dotted line 520.

Use of the adhesive layers as described above prevents damage to the electrode assemblies, and thus can be used to produce a lithium ion cell that is more robust, easier to manufacture, has a longer life, and is less prone to developing a short circuit. Such methods also allow the use of thinner separator materials, which can provide electrochemical cells with higher energy densities using the same active materials electrochemical cell size.

Unless defined otherwise, technical and scientific terms used herein have the same meaning as is commonly understood by one of skill in art to which this invention belongs. The terms “first,” “second,” and like, as used herein do not denote any order, quantity, or importance, but rather are used to distinguish one element from another. Also, the terms “a” and “an” do not denote a limitation of quantity, but rather denote the presence of at least one of referenced item. If ranges are disclosed, endpoints of all ranges directed to same component or property are inclusive of the endpoint and independently combinable. The modifier “about” used in connection with a quantity is inclusive of the stated value and has meaning dictated by context (e.g., includes degree of error associated with measurement of particular quantity).

While invention has been described with reference to an exemplary embodiment, it will be understood by those skilled in art that various changes may be made and equivalents may be substituted for elements thereof without departing from scope of invention. In addition, many modifications may be made to adapt a particular situation or material to teachings of invention without departing from essential scope thereof. Therefore, it is intended that invention not be limited to a particular embodiment disclosed as best mode contemplated for carrying out this invention, but that invention will include all embodiments falling within scope of appended claims.

What is claimed is:

1. A method of producing an electrode assembly, comprising:
disposing a thermoplastic polymer powder between a first surface of a first electrode and a first surface of a microporous separator to form a separator/electrode pre-assembly; and
adhering the first surface of the first electrode to the first surface of the microporous separator via the thermoplastic polymer powder to form a separator/electrode assembly, wherein the adhesive thermoplastic polymer does not form a solid layer.

2. The method of claim 2, wherein at least 50% of the surface area of the electrode and the microporous separator are in contact after adhering.

3. The method of claim 2, wherein the melting temperature of the thermoplastic polymer powder is lower than the melting temperature of the microporous separator.

4. The method of claim 2, wherein the electrode comprises an active layer comprising a binder.

5. The method of claim 4, wherein the melting temperature of the thermoplastic polymer powder is lower than the melting temperature of the binder.

6. The method of claim 2, wherein adhering is by laminating the first separator/electrode pre-assembly using roll lamination, flat bed lamination, or double belt press lamination.

7. An electrode assembly comprising:
a thermoplastic polymer adhesively disposed between a first surface of a first electrode and a first surface of a microporous separator, wherein the thermoplastic polymer does not form a solid layer.

8. The assembly of claim 7, wherein at least 50% of the surface area of the electrode and the microporous separator are in contact.
